(19) United States
(12) Patent Application Publication
(10) Pub. No.: US 2004/0173457 A1
(43) Pub. Date: Sep. 9, 2004

(54) Precision controlled thermostat for capillary electrophoresis

(76) Inventors: Arthur W. Miller, Woburn, MA (US); Chiranjit Deka, Andover, MA (US); Joseph M. Fallon, Wakefield, MA (US); Barry L. Karger, Newton, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/740,906

(22) Filed: Dec. 19, 2003

Related U.S. Application Data
(60) Provisional application No. 60/435,885, filed on Dec. 20, 2002.

(51) Int. Cl. C25B 7/00; G01N 27/26

(52) U.S. Cl. 204/451; 204/602

(57) ABSTRACT

A thermostat control system, that can be configured to include an array of two or more capillary columns or two or more channels in a microfabricated device, is disclosed. A thermally conductive material is in contact with each column or channel in the array. One or more independently controlled heating or cooling elements is positioned adjacent to or within the thermally conductive material, each heating or cooling element being connected to a source of heating or cooling. One or more independently controlled temperature sensing elements and one or more independently controlled temperature probes are also positioned adjacent to or within the thermally conductive material. Each temperature sensing element is connected to a temperature controller, and each temperature probe is connected to a thermometer. When the system is in use, each source of heating or cooling is automatically regulated by the temperature controller in response to feedback from one or more of the temperature sensing elements so as to control temperature stability to within a specified range, and the temperature controller is automatically regulated in response to feedback from one or more of the temperature probes to the thermometer so as to maintain the reference temperature of the thermally conductive material within a specified range of a pre-set target temperature.

### CROSS REFERENCE TO RELATED APPLICATIONS

This application claims the priority of U.S. Provisional Application No. 60/435,885 filed Dec. 20, 2002 entitled, PRECISION CONTROLLED THERMOSTAT FOR CAPILLARY ELECTROPHORESIS, the whole of which is hereby incorporated by reference herein.

### STATEMENT REGARDING FEDERALLY SPONSORED RESEARCH OR DEVELOPMENT

N/A

### BACKGROUND OF THE INVENTION

Capillary electrophoresis is a powerful technique used to separate molecules based on size and/or charge. In the analysis of samples requiring identical (or similar) separation conditions, it frequently is useful to have all of the columns of an array, e.g. all of the separation columns of a DNA sequencer or analyzer, held at the same temperature. On the other hand, there are many situations where the possibility of adjusting the temperature individually for each separation element of an array, or for clusters of separation elements within an array, would be of great practical importance. For example, an array of ten capillary columns, operating at ten different temperatures, could be used to find an optimum temperature for separation of certain specific species of DNA molecules. Conversely, ten different samples, each requiring a different temperature for optimum analysis, could be run in parallel with a similar increase in productivity beyond what individual runs carried out consecutively would achieve.

Foret et al., U.S. patent application Ser. No. 09/979,622, incorporated by reference herein, describes an embodiment of a thermostat array comprising essentially a number of heaters, each consisting of a cylindrical volume of thermally conductive material surrounded by an electrically powered heating element, whose power is adjusted in a feedback loop using an electrical temperature sensor such as an RTD, thermocouple, or thermistor. Although a single feedback system such as this can be used to maintain a thermostat setting with a high degree of stability (±0.01° C. to ±0.02° C.), it is extremely difficult to reset the temperature with this same degree of accuracy. “Resettability” is defined as the ability to set any given temperature (e.g., between 0° C.−150° C.) and achieve the same temperature every time, and for every heater. Because resettability to this level demands reference to some calibration standard, of which the most convenient is for absolute accuracy of temperature, the resettability requirements discussed herein are in practice usually absolute temperature accuracy requirements as well.

The need for a stringent resettability tolerance can arise in applications such as Constant Denaturant Capillary Electrophoresis (CDCE), in which DNA fragments are separated on the basis of minute differences in melting temperature. Under certain CDCE protocols, it is critical that the migration time differences between peaks be highly uniform, to obtain a high degree of automation of peak detection, and of high-confidence peak area measurement and matching of peaks and other features among electropherograms from different capillaries. Differences in separation temperature of only a few hundredths of a degree can shift peaks enough to make this infeasible, especially when peaks are small. (In general, whenever the signal-to-noise ratio is low, small peaks can be partly or fully masked by nearby larger peaks, Shifting of peaks can compound the likelihood of such events.) Therefore, while it may be adequate to set the CDCE run temperature only to a resolution of 0.1° C., the resettability of that temperature in these cases should be at least to a few hundredths of a degree, and preferably no more than ±0.01-0.02° C.

A fundamental cause for the difficulty in achieving resettability in such a system is the intrinsic inaccuracy of the various electronic components of the control system, which results from the materials and design of the components, and which can also be dependent on the ambient temperature of the electronic elements and on other factors. A particular example of this is the unit to unit variations in the performance of individual sensors. For example, assuming a sensor rated for stability of temperature response to within ±0.01° C., there might be unit-to-unit variation of the temperature response of ±0.1° C. or more. (This is error solely from the sensing element(s). The electronic measurement system for the sensor commonly contributes a large additional error.) This variance, often referred to as the “interchangeability tolerance,” defines how far a specific sensor within that group may vary from the nominal “Temperature-Response Curve.” Using such sensors, one could obtain a temperature stability of ±0.01° C., but the resettability or absolute temperature accuracy cannot be better than ±0.1° C. Thus, there exists a need in the art to obtain a practical solution whereby one can achieve a high degree of both stability and resettability simultaneously. Though this discussion uses a very stringent tolerance of ±0.01° C. for purposes of illustration, the same arguments apply for other values, e.g., when the required stability and resettability is ±0.1° C., but the unit-to-unit variation and other factors, including those discussed-below, lead to worse resettability than ±0.1° C.

One possible means by which the performance limitation just described can be overcome is to always use sensors (e.g., thermistors) in each heater that are specified to have an “interchangeability tolerance” of less than ±0.01° C. and to stabilize the ambient temperature for the electronics to a pre-specified temperature. Although theoretically possible, this solution is impractical for many industrial applications. For example, it is difficult to obtain commercially large numbers of thermistors that are pre-selected to meet an “interchangeability tolerance” of less than ±0.01° C. Therefore, in the thermostat array described by Foret et al., if one were to utilize commercial thermistors to control each heater, one would be required to calibrate each and every control thermistor individually and use a different set of calibration curves for temperature controls every time a new set of heaters is used for measurements. For multiple instruments with multiple heaters, this requirement places stringent demands on the system that require the tracking of each heater at all times. This is not only inconvenient but it also carries the risk of inadvertent but serious mistakes creeping into the overall process.

Even if one were to implement such a calibration and tracking mechanism, the problems caused due to variations in the electronic components still remain. As a result, even with all the tracking and calibration of individual thermistors, one may not get repeatable temperatures unless the ambient temperature of the control electronics itself is also thermally stabilized, or provided with highly accurate internal temperature measurement and subjected to extensive calibration. Such a requirement renders the system very complex and expensive to build. Thus, a better approach is still desirable.

### BRIEF SUMMARY OF THE INVENTION

The present invention provides a method for overcoming these problems and provides a thermostat system that permits both stability and resettability of temperature to within less than ±0.02° C., using commercially available sensors and using a design that does not require the electronics to be maintained in any thermally stabilized environment.

In one embodiment, the invention is directed to a thermostat control system that can be configured to include one or more capillary columns or one or more channels in a microfabricated device. Individual columns or channels, or clusters of columns or channels can, preferentially, be associated in arrays. A thermally conductive material is in contact with each column or channel. One or more independently controlled heating or cooling elements is positioned adjacent to or within the thermally conductive material, each heating or cooling element being connected to a source of heating or cooling. One or more independently controlled temperature sensing elements and one or more independently controlled temperature probes are also positioned adjacent to or within the thermally conductive material. Each temperature sensing element is connected to a temperature controller, and each temperature probe is connected to a reference thermometer. When the system is in use, each source of heating or cooling is automatically regulated by the temperature controller in response to feedback from one or more of the temperature sensing elements so as to control temperature stability to within a specified range, and the temperature controller is automatically regulated in response to feedback from one or more of the temperature probes to the thermometer so as to maintain the reference temperature of the thermally conductive material within a specified range of a pre-set target temperature.

### BRIEF DESCRIPTION OF THE SEVERAL VIEWS OF THE DRAWINGS

Other features and advantages of the invention will be apparent from the following description of the preferred embodiments thereof and from the claims, taken in conjunction with the accompanying drawings, in which:

FIGS. 1a-1c show one embodiment of a cluster of individual capillary columns with associated temperature control and monitoring elements suitable for use in the thermostat array control system according to the invention. FIGS. 1a and 1b are an axial section view and a cross-axial section view, respectively, of the column cluster, and FIG. 1c is a schematic drawing of the temperature control and monitoring elements of this embodiment;

FIGS. 2a and 2b shows another embodiment of a cluster of individual capillary columns for use in the thermostat array control system according to the invention;

FIG. 3 is a schematic drawing of the temperature control system for an array of six heaters suitable for use in the thermostat array control system according to the invention;

FIG. 4 is a schematic drawing showing an embodiment of distributed temperature control according to the invention, in which four heaters of the present invention are incorporated in four different single capillary electrophoresis instrument;

FIG. 5 shows an embodiment of the thermostat array control system according to the invention integrated on a microfabricated device;

FIG. 6 shows an example of the use of the thermostat array control system according to the invention for CDCE analysis;

FIG. 7 shows the results of six heaters maintained at six different temperatures within less than ±0.02° C. of their respective set temperatures using the thermostat array control system of the invention;

FIGS. 8a and 8b are graphs showing the results from the use of the thermostat array control system according to the invention for optimization of CDCE separation of a PCR amplified DNA sample; and

FIGS. 9a-9c are graphs showing reproducible CDCE separation using the thermostat array control system according to the invention.

### DETAILED DESCRIPTION OF THE INVENTION

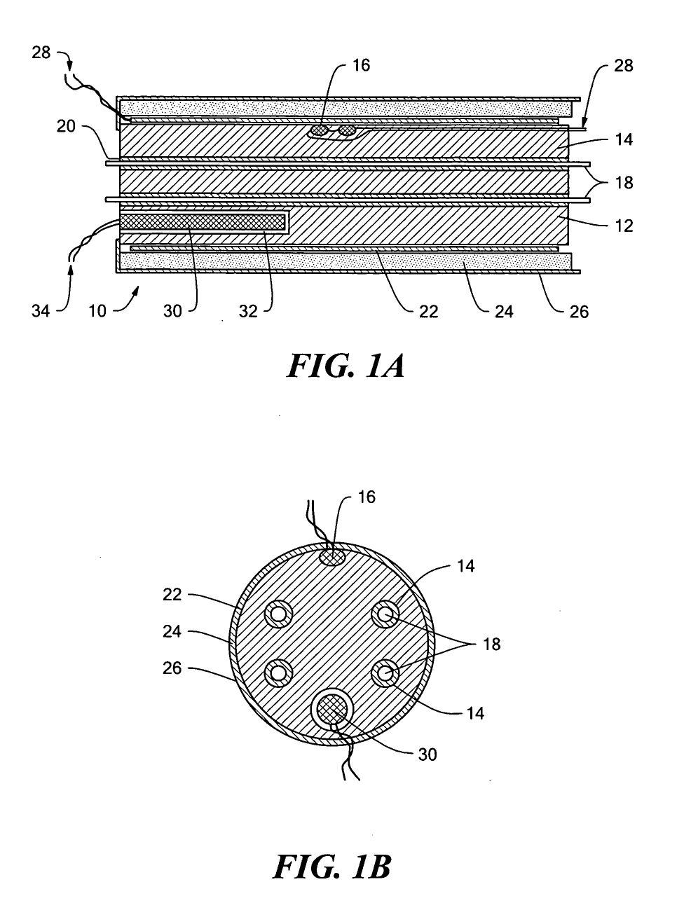

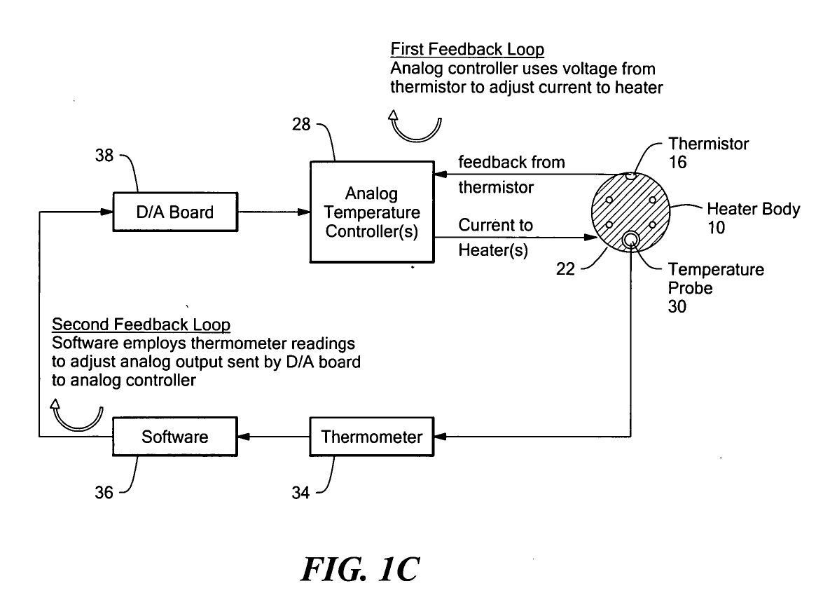

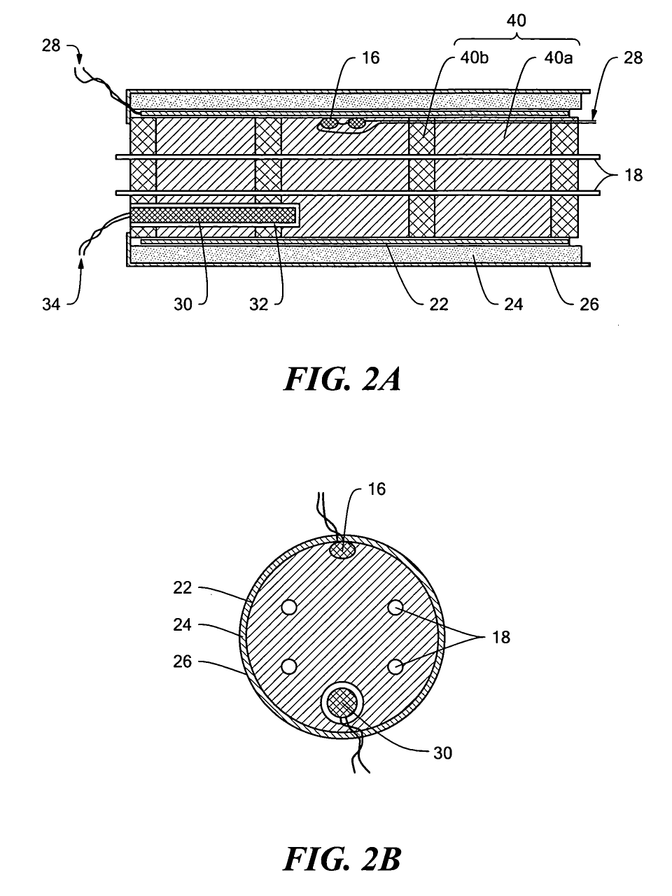

Described herein are individual columns and arrays of independently controlled thermostat systems according to the invention useful, e.g., for column separations. Individual thermostat control systems in an array can be associated with individual capillary columns (or channels in a microfabricated device) or with groups (clusters) of such columns or channels. An array of independently controlled thermostats according to the invention is useful, e.g., in constant denaturant capillary electrophoresis as described in K. Khrapko et al., Constant Denaturant Capillary Electrophoresis (CDCE): A High Resolution Approach to Mutational Analysis. Nucl. Acid. Res., 22, 1994, 364-269. In CDCE, DNA fragments, for example, are analyzed based on differences in melting temperature. Specific embodiments of individual clusters of capillary columns with associated individually controlled thermostats suitable for use in the thermostat array control system of the invention are shown in FIGS. 1a-1c and FIGS. 2a-2b. There are many other embodiments that can be derived from those described herein, which are suitable for alternative applications, as will be obvious for one skilled in the art. For example, a temporal gradient may be repeated in a cyclic manner by ramping the temperature up and down during the separation, such as is done in cycling temperature capillary electrophoresis (CTCE), a technique described in Minarik et al., Cycling gradient capillary electrophoresis: a low-cost tool for high-throughput analysis of genetic variations, Electrophoresis 2003, 24, 1716-1722. Simpler nonrepeating gradients and a wide variety of temperature programming methods would also constitute suitable applications; e.g., the methods discussed in Li et al., Integrated platform for detection of DNA sequence variants using capillary array electrophoresis, Electrophoresis 2002, 23, 1499-1511. While the focus here is on CDCE and capillaries, the current invention could equally well apply to other techniques, including ones not involving electrophoresis, in which much wider bore tubing is employed (e.g., several millimeters).

In one embodiment, as shown in FIGS. 1a and 1b, the solid-state heater component 10 of the thermostat system according to the invention comprises a cylindrical block 12 of a thermally conductive material such as copper, brass, or stainless steel, about 6 inches long and 1 inch in diameter. Hollow channels 14 formed by drilling through the solid cylindrical block 12 run through the thermally conductive material parallel to the axis of this cylinder. One or more temperature sensors 16 (e.g., thermistors) are embedded on shallow grooves on the surface of the cylindrical body. Stainless steel capillary tubes 18, inserted through hollow channels 14 in the cylindrical body, are held in place by filling up the space between the outer surface of each tube and the inner surface of each channel, e.g., with a thermal epoxy 20. The cylindrical outer surface of thermally conductive block 12 is wrapped with a flexible heating element 22 then covered further with a layer of insulating foam 24 and protected by a heat shrink tube 26.

An advantageous feature in this embodiment is the presence of multiple capillaries through the heater. With, e.g., four capillaries, as more clearly shown in FIG. 1b, experiments can be designed such that a target DNA sequence can be analyzed completely within one CDCE run, using a separate capillary for a pooled population of interest, a pooled control population, a positive control and a negative control. However, the number of capillaries per heater is not a limitation, and any number of capillaries can be incorporated in an individual heater. Furthermore, multiple capillaries in a single heater might be employed differently from the manner just detailed under other circumstances. Also, as described subsequently, groups of such heaters can be used to analyze different DNA targets (requiring different separation temperatures) simultaneously.

As shown in schematic form in FIG. 1c, temperature controller 28, connected to heating element 22, provides a current to the heating element that is continuously adjusted to maintain a stable temperature in response to the continuous feedback input it receives from the sensor 16. Referring also to FIG. 1a, a precision temperature probe 30, e.g., a thermistor encased in a stainless steel tube, about 3 inches in length and 0.125 inches in diameter, in which the thermistor is embedded using thermally conductive epoxy, is inserted in a hole 32 and used to monitor the absolute temperature within the thermally conductive block 12 of the heater body. This temperature probe 30 is connected to a digital thermometer 34, which provides a feedback to a computer 36 containing an analog output board 38 (D/A board), which is connected to the temperature controller 28. The analog output board 38 is used to adjust the primary operating reference voltage of the temperature controller to match the target temperature to within a desired range.

It should be noted that wherever heating elements are referenced herein, it would be possible to add cooling elements as well for greater temperature control capability. Heating and cooling elements might also be combined into a single heating/cooling element, such as a Peltier device. It should also be noted that temperature sensors and temperatures probes are the same category of device (temperature transducers), and that the two terms are used herein only for clarity in distinguishing the two levels of temperature control in the system according to the invention. Temperature sensors and probes may be thermisters, thermocouples, RTDs, PRTs, SPRTs, ICs (semiconductor devices), infrared detectors, reversible temperature indicating labels, or any material or device in which some measurable property changes in a fashion that can be correlated to temperature. Such properties include resistance, output current, visible color, and infrared light emission.

While the preferred embodiment described herein employs an analog controller, this unit may be substituted in other embodiments by other types of controllers. As one example, the control logic (such as on-off control, proportional control, PID control, fuzzy logic control, or combinations of these in single-loop or multiloop fashion) may reside in software on a computer, which through additional hardware such as a solid-state relay and an external power supply, pulses current to a heating/cooling element.

In another embodiment, as shown in FIGS. 2a-2b, the solid-state heater component of the thermostat comprises a cylindrical body 40 comprising a first thermally conductive material 40a, which is cast around four stainless steel capillaries 18 held in place by a number of parallel circular discs 40b of a second thermally conductive material. One or more temperature sensors 16 (e.g., thermistors) are embedded on shallow grooves on the surface of the thermally conductive cylindrical body 40. The cylindrical outer surface of the thermally conductive block 40 is wrapped with a flexible heating element 22, then covered further with a layer of insulating foam 24, and protected by a heat shrink tube 26. The temperature control mechanism is the same as described for the embodiment above (FIG. 1c).

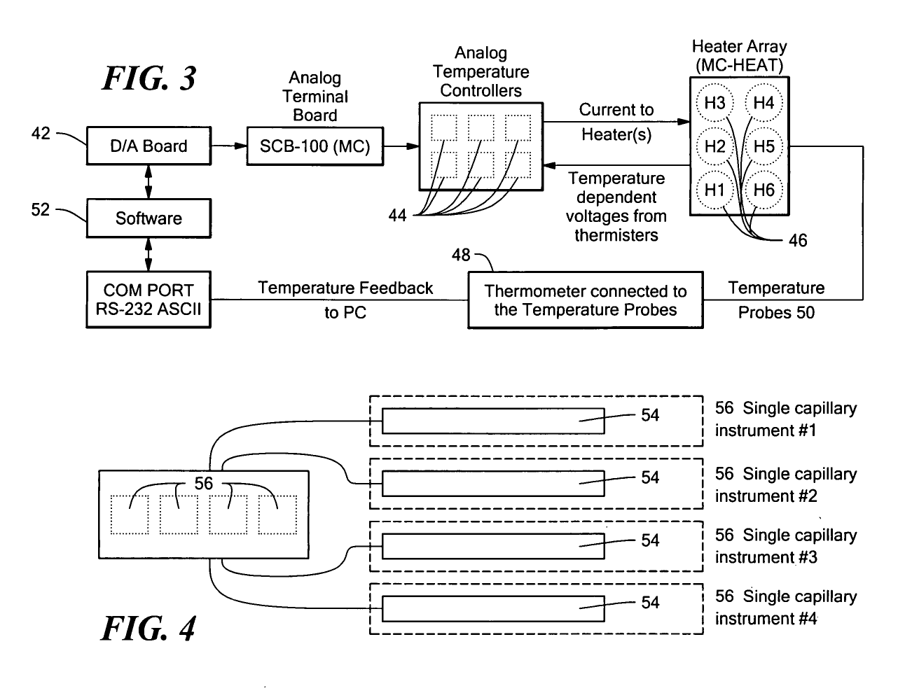

Temperature control of an array of six heaters is shown in FIG. 3. In this embodiment, an independent reference voltage is sent by the D/A board 42 to each analog temperature controller 44. The controller then monitors a voltage from a thermistor embedded in a heater 46, which is a measure of the temperature of the thermistor. The controller continuously adjusts the current supplied to the heater until the voltage from the thermistor is the same as the reference voltage. The thermometer 48 monitors temperature concurrently temperature probes 50 and reports its measurements to the control software 52. At frequent intervals, the software checks whether the heater temperature has been stable within a preset range for a predetermined time interval. If this is true, a test is performed to establish whether this stable temperature is within tolerance of the target temperature. If the difference from the target temperature exceeds the tolerance, a correction to the reference voltage for that heater is computed, and the D/A board is set to send the corrected voltage on the appropriate output channel. The process of waiting for heater temperature to stabilize, testing the temperature against a tolerance and correcting the reference voltage is repeated indefinitely.

While in principle it would be possible to substitute the controlling temperature sensors with the much more highly accurate calibrated thermometer and attached probes, and thus avoid the extra control loop, there are practical difficulties with such an approach. One is that the rapid responses to temperature disturbances required demand rapid temperature measurements, but rapid measurements come at the cost of degrading accuracy. Another problem is that for best control, the controlling sensors should be located very close to the heating/cooling element, and are therefore typically embedded in the apparatus and difficult to easily replace, reuse, or recalibrate. Difficulties with tracking logistics have already been remarked upon. In the current invention, a single multichannel thermometer can be used to provide highly accurate temperature for many different temperature-controlled zones, using probes that can easily be removed from either the thermometer or from the zone being controlled. This reduces the number of expensive, high-tolerance components needed to control multiple heaters. Because the same thermometer and probes can be used over time for many different sets of heaters, tracking problems are reduced as well.

FIG. 4 illustrates an embodiment of distributed temperature control, in which four heaters 54 of the present invention are incorporated in four different single capillary electrophoresis instruments 56 (which in principle could instead be four different multicapillary instruments). Each heater is separately controlled by a separate analog temperature controller 58 within the temperature control system of the invention, and the instruments are operated independently. All the analog controllers are physically positioned at a central location, similarly to the fashion illustrated in FIG. 3. A single multichannel digital thermometer is at that central location as well and is used to provide the second level of control for all the instruments. Leads for sensors, probes, and heater power are run from the central position to the different instruments.

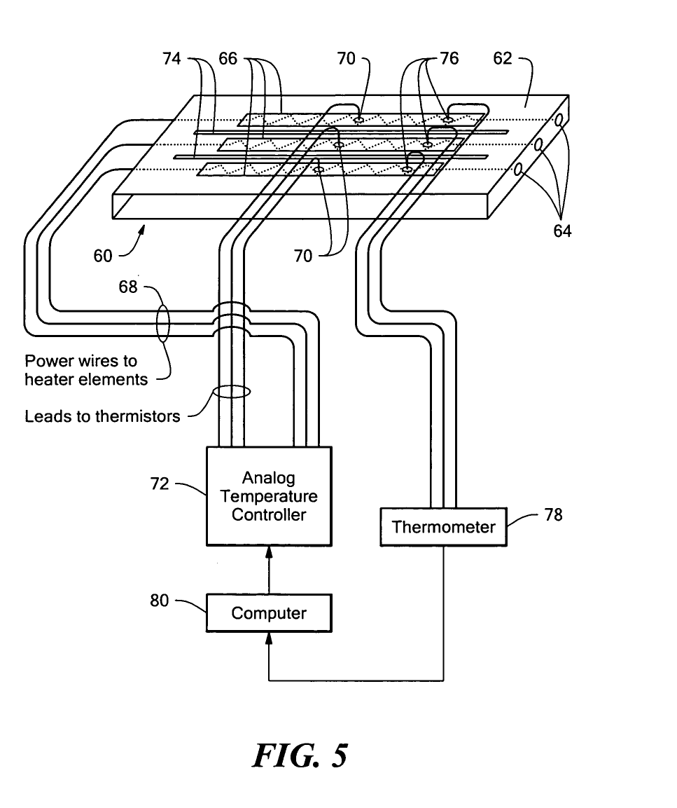

The examples described above show a thermostat system suitable for an array of discrete capillaries. Precise and resettable independent control of temperature is also important in microfabricated devices. The entire thermostat/capillary column array described here, including heaters and sensors (thermistors, RTDs, etc.) and, if needed, also the controllers, can be integrated on a microfabricated device, e.g., a microchip. Due to the small size of microchips and the good thermal conductivity of most substrate materials used for fabrication, e.g., fused silica, the closely neighboring heated/cooled areas of the thermostat array could strongly influence each other. To prevent this type of thermal communication, microdevices implemented with the thermostat array of the invention need to be equipped with heat insulating regions between individual temperature controlled channels or clusters of channels. An example of such a microdevice is depicted in FIG. 5.

Referring to FIG. 5, planar microchip 60, having a fused silica chip body 62, contains multiple channels 64, each associated with a heating/cooling element 66. Wires 68 connect heating/cooling elements 66 to individual temperature controllers 72. Temperature sensors 70 provide feedback to temperature controllers 72, and temperature probes 76 are connected to reference thermometer 78, which provides feedback to computer 80, as described above. Temperature control is as given for previous embodiments.

To eliminate heat transfer between individual channel/heating element combinations, through cuts 74 are made between the channels. The cuts can be further filled with an insulating material such as polyurethane or polystyrene foam. Heating elements 66 can be attached from the top and/or the bottom of the microchip. In addition, the vertical walls of cuts 74 could be coated with a conductive material and connected to the current source so as to provide a source of heating/cooling surrounding a desired channel.

The temperature sensors 70 and probes 76 (Pt, thermistors, or other) can be attached from either side of a channel 64. Alternatively, the heating element itself can serve as the temperature sensing element if it is made from a material that changes resistance over time. For example, a conductive (Pt, Cr, Au, conductive plastic) layer can be deposited directly on the surface of the microdevice (or inside before the layers of the device are bonded) by using sputtering or chemical vapor deposition techniques. Similarly to the earlier described configuration for capillary column thermostat arrays, multiple channels could also be heated (cooled) by a single heating/cooling element, and clusters of such channels could be associated in a thermostat array of the invention wherein different clusters within the array are independently controlled.

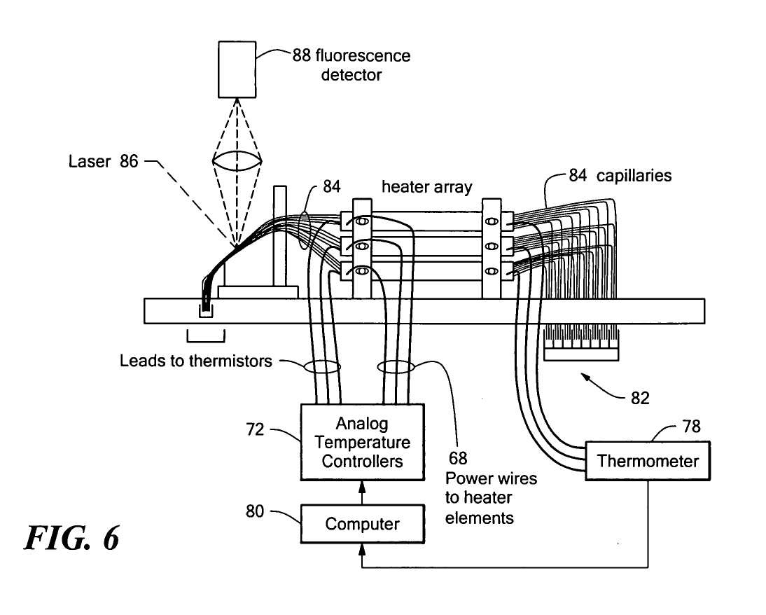

An example of the use of the thermostat array of the invention in a system for CDCE analysis is shown in FIG. 6.

Referring to FIG. 6, solid state thermostat array 82 includes separation capillaries 84 for CDCE analysis, e.g., of separate mitochondrial DNA samples. Samples are injected into individual capillaries 84. The capillaries are also positioned for comprehensive collection of zones exiting the capillaries. Laser illumination system 86 produces two point illumination for, e.g., laser induced fluorescence (LIF) detection using a spectrograph/CCD detector 88. Temperature control is as shown in FIG. 5. In this particular design, the thermostats are used to maintain a constant temperature in each separation capillary (a different temperature in each column) to achieve the desired resolution of the DNA fragments, which are consecutively subjected to LIF velocity measurement and fraction collection.

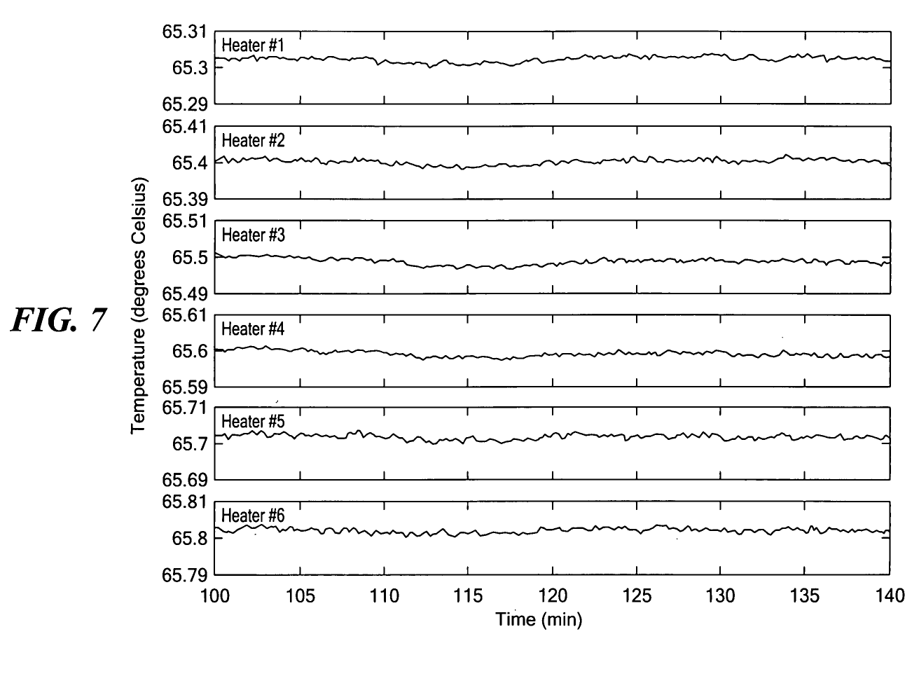

FIG. 7 shows temperature readings over an hour for six heaters set for six different temperatures using the control system of the invention. Temperatures are shown to be maintained within ±0.01° C. of their respective set temperatures, based on the specifications of thermometer employed.

The following examples are presented to illustrate the advantages of the present invention and to assist one of ordinary skill in making and using the same. These examples are not intended in any way otherwise to limit the scope of the disclosure.

### EXAMPLE 1

### CDCE Temperature Optimization.

A thermostat array containing six heaters, as described herein, was incorporated in a modified DNA sequencer (based on Spectrumedix 2410) for mutation discovery in pooled populations using CDCE. For CDCE of a PCR amplified DNA sample, ideally one might set the CDCE temperature such that for each target sequence there would be four distinct and well resolved peaks when a mutation is present (the wildtype homoduplex, the mutant homoduplex and two wildtype-mutant heteroduplexes). This temperature is usually close to but not exactly equal to the theoretical melting temperature (Tm) calculated for the wildtype homoduplex. To determine the optimum CDCE temperature, an initial CDCE experiment is conducted on the sample in which the six heaters in the thermostat array in the instrument are set at six slightly different temperatures in a narrow range around the calculated Tm.

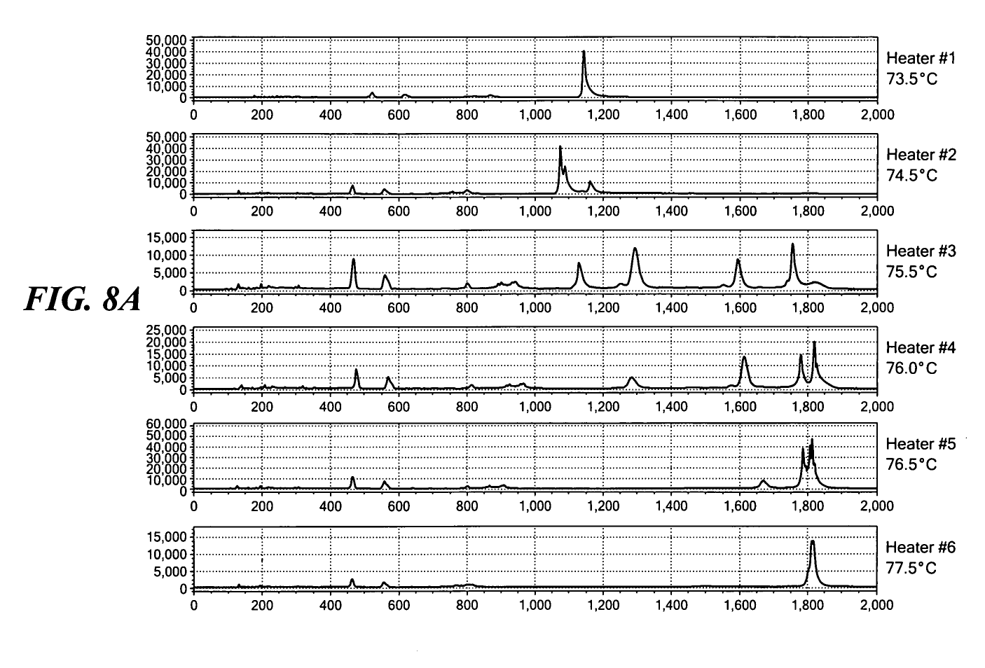

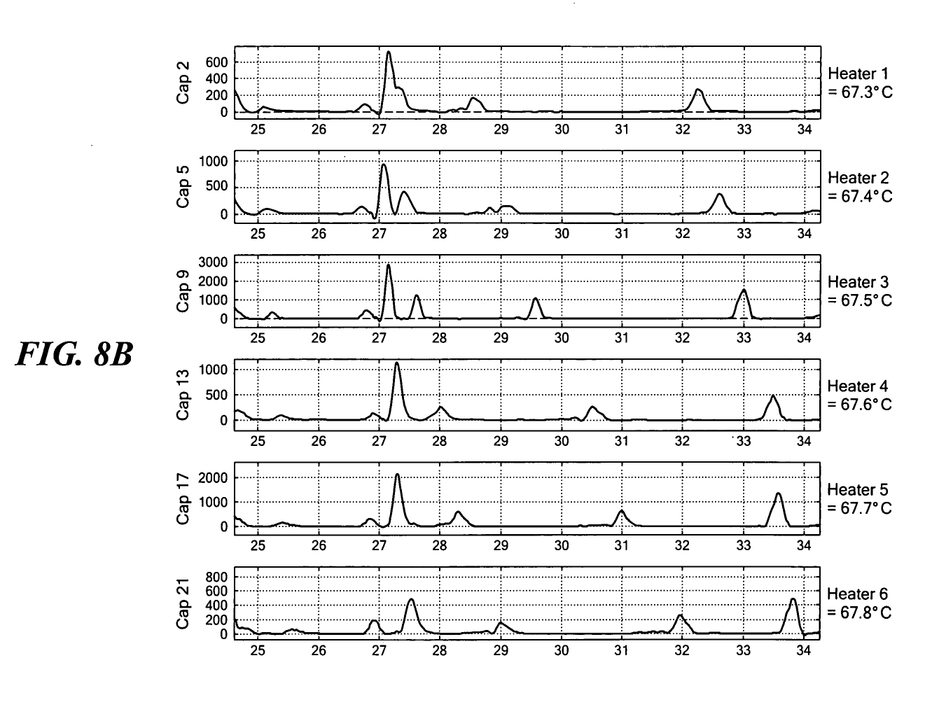

FIG. 8a illustrates such a temperature optimization for a DNA fragment denoted as CTLA-4E1. The same CTLA-4E1 sample was injected into one capillary in each of the six heaters, where each heater was set to a different temperature in the range 73.5° C. to 77.5° C. At 73.5° C., only a single peak was observed for the target sequence, representing the case in which all species of the DNA molecules shown under this peak are in the unmelted state. At 74.5° C., this peak split into two distinct peaks, indicating that the one of the heteroduplex species is already partially melted while the wildtype homoduplex, mutant homoduplex, and the other heteroduplex are all in a mostly unmelted state. At 75.5° C., four distinct, well resolved peaks were observed, which indicates maximum differential melting conditions between the four species. At 76.0° C., the mutant homoduplex peak is separated further from the wildtype, but at the same time, the resolution between the three mutant peaks started deteriorating significantly. At 76.5° C., the mutant peaks coalesced and the wildtype peaks got closer to the mutant peak. This represents the condition in which the mutant homoduplex and two heteroduplexes are all nearly completely melted and the wildtype partially melted. Finally, at 77.5° C., all four peaks coalesced into a single peak, representing the case in which the low-melting domains of all the four species were completed melted with only the high-melting domain remaining intact to hold the partially opened double-stranded DNA fragment together. From this example, one would conclude that 75.5° C. was the optimum CDCE temperature.

As can be seen, quite different results are obtained with even half a degree of temperature difference. FIG. 8b shows significant variations in migration time and peak resolution with only 0.1° C. difference in temperature between capillaries. These results emphasize the importance of maintaining a specific temperature during such an analysis, as is possible using the system of the invention.

### EXAMPLE 2

### Separation Reproducibility in a Modified SpectruMedix DNA Sequencer.

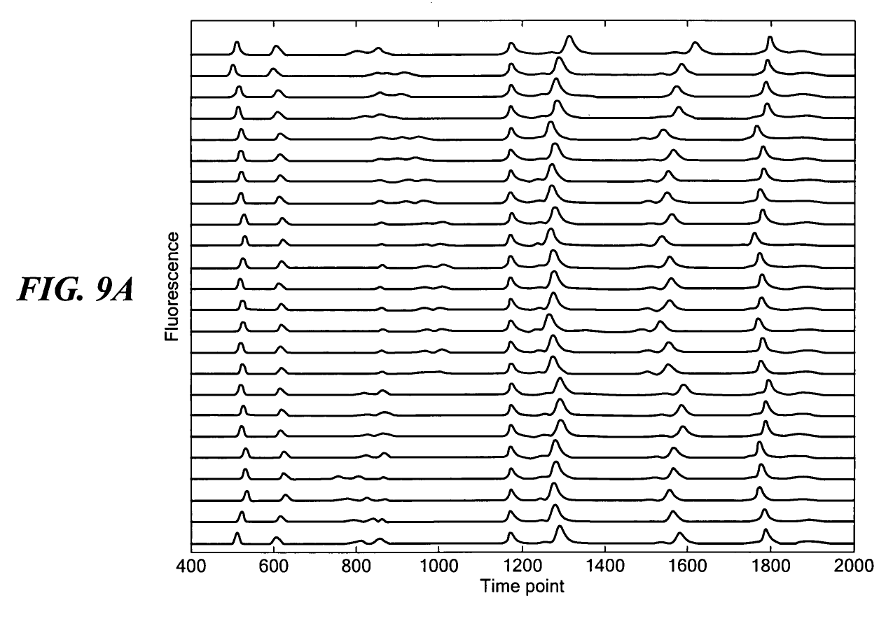

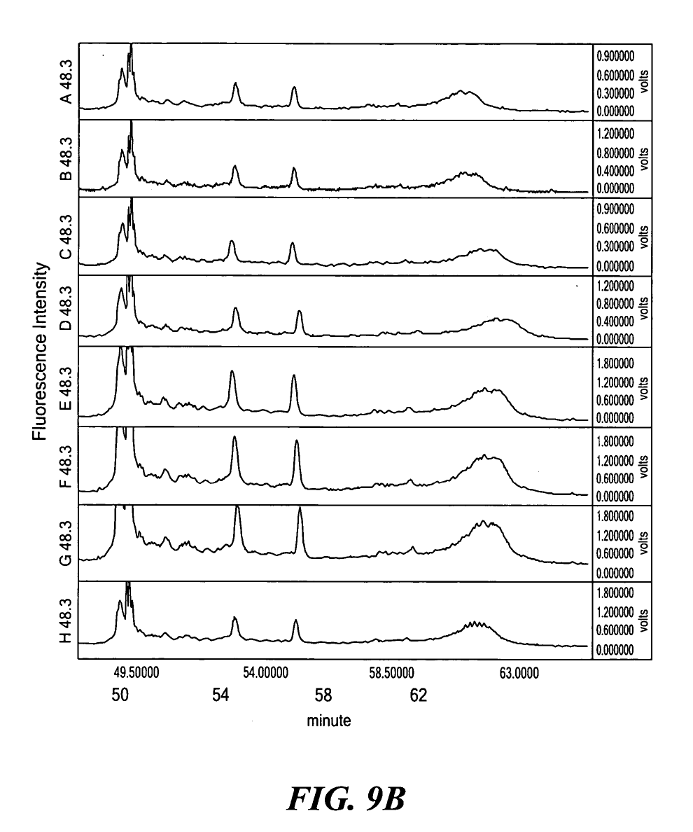

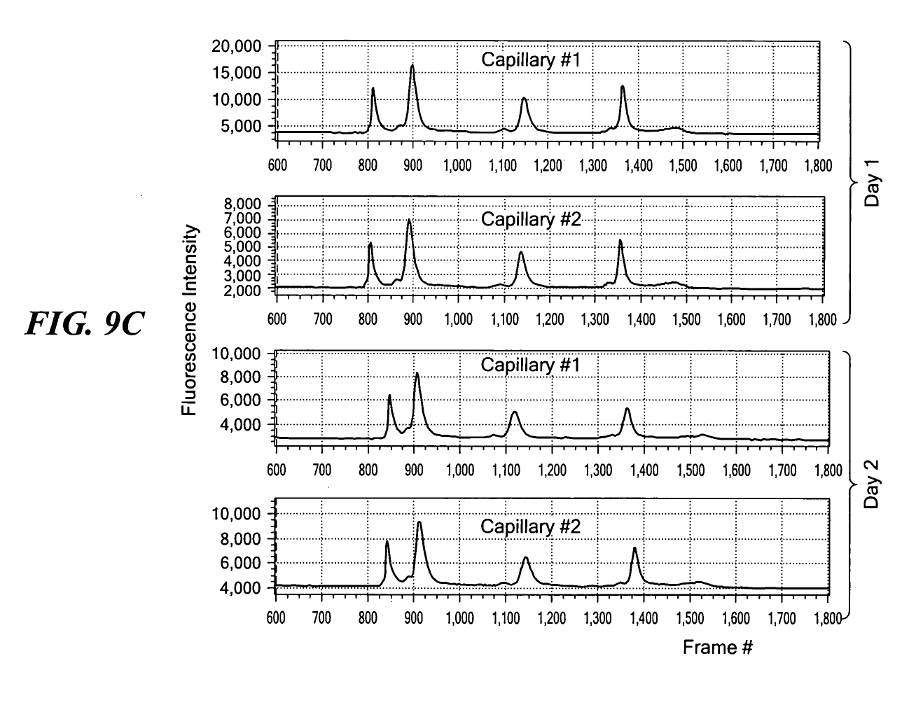

Example 1 demonstrated the importance of accurate temperature settings for CDCE. The present experiment demonstrates the ability of the heater array to produce the same temperature environment for each column exactly as set, and to generate reproducible CDCE separation. Variations in the migration time of the four peaks were used as measures of this reproducibility. For this experiment, a CTLA-4E1 sample was injected into all the 24 capillaries and run at the optimum CDCE temperature of 75.5° C. The resulting electropherograms, aligned to the peak occurring just before time point 1200, are shown in FIG. 9a. The four major peaks starting with this alignment peak represent the homoduplex and heteroduplex species for this sample. For analytical purposes, a key metric is the migration time differences between pairs of these peaks. Comparison with FIGS. 8a and 8b shows that the migration time differences shown here reflect very uniform temperature between capillaries and heaters.

### EXAMPLE 3

### Separation Reproducibility in a Modified Beckman Coulter DNA Sequencer.

In this experiment, two heaters of the present invention were incorporated in a commercial DNA sequencer (CEQ 2000, Beckman Coulter Inc.). A modified 8-capillary array was made by passing 4 capillaries through the first heater and the remaining 4 capillaries through a second heater. The temperature control system of the present invention was connected directly to the two heaters. CDCE separation was conducted on identical samples through each of the 8 capillaries in the array. Temperature had previously been optimized so that the homoduplex peaks migrated at nearly the same position, but the heteroduplex peaks migrated significantly slower. FIG. 9b shows the results after alignment to the leading homoduplex peaks. The heteroduplex peaks (just before and just after 54 minutes) migrate at a distance from the homoduplexes that is constant across capillaries and heaters to within a single peak width.

### EXAMPLE 4

### Resettability

This experiment demonstrates the ability of the heaters of the present invention to reset to exactly the same temperatures in different days. FIG. 9c shows the resettability of temperatures in the heaters according to the invention. On two different days, an identical sample was injected in two capillaries of the modified SpectruMedix sequencer used in Example 1. Again referencing FIG. 8a and 8b for the effect of small temperature changes on separation, the high uniformity of migration times in FIG. 9c demonstrates, even without aligning the electropherograms to a common peak, that a very similar temperature was achieved both between capillaries and between days. The resettability possible with the system of the invention permits transferring highly stringent run conditions from one multicapillary instrument to another, or between multicapillary and single-capillary instruments.

Although the specific examples shown here are related to CDCE, the thermostat array control system of this invention can be used in any physical, chemical, or bioanalytical application in which stable, accurate and resettable temperature is critical to achieving quality results, including mutation discovery by SSCP, cellular analysis by flow cytometry, instrumentation for immunoassays (binding assays), automated and inline sample preparation for hematology and/or immunology, and protein separations, liquid chromatography including high performance liquid chromatography, and long-read DNA sequencing. Implementations of the same approach with miniature heaters embedded in microfabricated devices can also be contemplated. Moreover, the method can be extended to the production of temporal and spatial temperature gradients during separation. For example, temporal gradients are achieved by ramping the target temperature in the control software during the separation, and spatial gradients are achieved by setting different target temperatures for a plurality of physically separated heating elements located on a given heater. Temperature cycling, and other temperature profiles of arbitrary complexity, are also feasible. Further, this heater system can be used both for CTCE and CDCE within a single instrument. In one embodiment, one could conduct CTCE runs for a preliminary separation of heteroduplex peaks and then follow up with a CDCE run for a higher resolution separation and analysis.

While the present invention has been described in conjunction with a preferred embodiment, one of ordinary skill, after reading the foregoing specification, will be able to effect various changes, substitutions of equivalents, and other alterations to the compositions and methods set forth herein. It is therefore intended that the protection granted by Letters Patent hereon be limited only by the definitions contained in the appended claims and equivalents thereof.

What is claimed is:

1. A thermostat control system comprising:
one or more capillary columns or one or more channels in a microfabricated device;
a thermally conductive material in contact with said capillary columns or channels;
one or more independently controlled heating or cooling elements positioned adjacent to or within said thermally conductive material, wherein each heating or cooling element is connected to a source of heating or cooling;
one or more independently controlled temperature sensing elements positioned adjacent to or within said thermally conductive material, wherein each temperature sensing element is connected to a temperature controller; and
one or more independently controlled temperature probes positioned adjacent to or within said thermally conductive material, wherein each temperature probe is connected to a thermometer and
wherein, when said system is in use, each said source of heating or cooling is automatically regulated by said temperature controller in response to feedback from one or more of said temperature sensing elements so as to control temperature stability to within a specified range, and said temperature controller is automatically regulated in response to feedback from one or more of said temperature probes to said thermometer so as to maintain the reference temperature of said thermally conductive material within a specified range of a pre-set target temperature.

2. The control system of claim 1, said system comprising multiple independent said capillary columns or multiple independent said channels in a microfabricated device, or multiple independent clusters of said capillary columns or said channels, wherein said columns or channels are distributed among different instruments.

3. A thermostat control system comprising:
one or more capillary columns;
a capillary body support surrounding each said capillary column;
two or more discs of a first thermally conductive material supporting said capillary body support or supports;
a second thermally conductive material surrounding said capillary body support or supports adjacent to said discs of said first thermally conductive material, wherein the melt temperature of said first thermally conductive material is higher than the melt temperature of said second thermally conductive material;
one or more independently controlled heating or cooling elements positioned adjacent to or within said first and second thermally conductive materials, wherein each heating or cooling element is connected to a source of heating or cooling; and
one or more independently controlled temperature sensing elements positioned adjacent to or within said first and second thermally conductive materials, wherein each temperature sensing element is connected to a temperature controller.

4. The control system of claim 3, further comprising:
one or more independently controlled temperature probes positioned adjacent to or within said first and second thermally conductive materials, wherein each temperature probe is connected to a thermometer and
wherein, when said system is in use, each said source of heating or cooling is automatically regulated by said temperature controller in response to feedback from one or more of said temperature sensing elements so as to control temperature stability to within a specified range and said temperature controller is automatically regulated in response to feedback from one or more of said temperature probes to said said thermometer so as to maintain the reference temperature of said first and second thermally conductive materials within a specified range of a pre-set target temperature.

5. The control system of claim 4, said system comprising multiple independent said capillary columns, or multiple independent clusters of said capillary columns, wherein said columns or channels are distributed among different instruments.

6. A thermostat array control system comprising:
two or more capillary columns or two or more channels in a microfabricated device, wherein said two or more columns or said two or more channels are associated in an array;
a thermally conductive material in contact with said capillary columns or channels;
one or more independently controlled heating or cooling elements positioned adjacent to or within said thermally conductive material, wherein each heating or cooling element is connected to a source of heating or cooling;
one or more independently controlled temperature sensing elements positioned adjacent to or within said thermally conductive material, wherein each temperature sensing element is connected to a temperature controller; and
one or more independently controlled temperature probes positioned adjacent to or within said thermally conductive material, wherein each temperature probe is connected to a thermometer and
wherein, when said system is in use, each said source of heating or cooling is automatically regulated by said temperature controller in response to feedback from one or more of said temperature sensing elements so as to control temperature stability to within a specified range, and said temperature controller is automatically regulated by feedback from one or more of said temperature probes to said said thermometer so as to maintain the reference temperature of said thermally conductive material within a specified range of a pre-set target temperature.

7. A thermostat array control system comprising:
two or more capillary columns, wherein said two or more columns are associated in an array;
a capillary body support surrounding each said capillary column;
two or more discs of a first thermally conductive material supporting said capillary body supports;
a second thermally conductive material surrounding said capillary body supports adjacent to said discs of said first thermally conductive material;
one or more independently controlled heating or cooling elements positioned adjacent to or within said first and second thermally conductive materials, wherein each heating or cooling element is connected to a source of heating or cooling; and
one or more independently controlled temperature sensing elements positioned adjacent to or within said first and second thermally conductive materials, wherein each temperature sensing element is connected to a temperature controller.

8. The control system of claim 7, further comprising:
one or more independently controlled temperature probes positioned adjacent to or within said first and second thermally conductive materials, wherein each temperature probe is connected to a thermometer and
wherein, when said system is in use, each said source of heating or cooling is automatically regulated by said temperature controller in response to feedback from one or more of said temperature sensing elements so as to control temperature stability to within a specified range and said temperature controller is automatically regulated in response to feedback from one or more of said temperature probes to said said thermometer so as to maintain the reference temperature of said first and second thermally conductive materials within a specified range of a pre-set target temperature.

9. The control system of claim 6, wherein said one or more heating or cooling elements are positioned adjacent to individual said columns or channels and wherein each individual said column or channel is thermally insulated from every other said column or channel.

10. The control system of claim 6, said system further comprising multiple said columns or channels, wherein two or more of said multiple columns or channels are heated or cooled by a single heating or cooling element and multiple clusters of such columns or channels heated or cooled by a single heating or cooling element are associated in said thermostat array control system and wherein said columns or channels heated or cooled by a single heating or cooling element within a cluster of said columns or channels can be maintained at the same temperature and different clusters within said array are independently controllable.

11. The control system of claim 7, wherein said one or more heating or cooling elements are positioned adjacent to individual said columns and wherein each individual said column is thermally insulated from every other said column.

12. The control system of claim 7, said system further comprising multiple said columns, wherein two or more of said multiple columns are heated or cooled by a single heating or cooling element and multiple clusters of such columns heated or cooled by a single heating or cooling element are associated in said thermostat array control system and wherein said columns heated or cooled by a single heating or cooling element within a cluster of said columns can be maintained at the same temperature and different clusters within said array are independently controllable.

13. The control system of claim 6 or claim 7, wherein said one or more heating or cooling elements are also used as said temperature sensing elements.

14. The control system of claim 6, wherein said capillary columns or channels are suitable for use in a separation method calling for an electric field and said columns or channels are electrically isolated from said heating or cooling elements.

15. The control system of claim 7, wherein said capillary columns are suitable for use in a separation method calling for an electric field and said columns are electrically isolated from said heating or cooling elements.

16. The control system of claim 6, wherein said heating or cooling elements surround said capillary columns or channels.

17. The control system of claim 7, wherein said heating or cooling elements surround said capillary columns or channels.

18. The control system of claim 6, comprising two or more independently controlled heating or cooling elements associated with an individual said column or channel, wherein said two or more heating or cooling elements are positioned along said associated column or channel so as to be capable of inducing a thermal gradient along the length of said column or channel.

19. The control system of claim 7, comprising two or more independently controlled heating or cooling elements associated with an individual said column, wherein said two or more heating or cooling elements are positioned along said associated column so as to be capable of inducing a thermal gradient along the length of said column.

20. The control system of claim 6, wherein said independently controlled heating or cooling elements associated with an individual said column or channel are configured for temperature programming.

21. The control system of claim 7, wherein said independently controlled heating or cooling elements associated with an individual said column are configured for temperature programming.

22. The control system of claim 6 or claim 7, wherein said heating or cooling elements are solid-state.

23. The control system of claim 6 or claim 7, wherein said heating or cooling elements are a fluid.

24. The control system of claim 23, wherein said fluid heating or cooling element is a liquid.

25. The control system of claim 23, wherein said fluid heating or cooling element is a gas.

26. A method of finding the optimum temperature for an analysis procedure for a particular sample, said method comprising the steps of:
providing the thermostat array control system of claim 6;
determining the number of different temperature values to be examined;
including within the thermostat array a number of columns or channels equal to the number of different temperature values to be examined;
configuring each said column or channel for carrying out said analysis procedure for said sample;
adjusting said temperature controller associated with said thermostat array so as to maintain the temperature at each individual said column or channel at one of said different temperature values to be examined;
carrying out said analysis procedure on different aliquots of said sample simultaneously in each of said columns or channels, each of said individual columns or channels being maintained at a different one of said temperature values to be examined; and
comparing the results of said analysis procedure carried out in said individual columns or channels to determine the optimum temperature for said analysis procedure for said sample.

27. The method of claim 26, wherein said analysis procedure is constant denaturant capillary electrophoresis.

28. The method of claim 26, wherein said analysis procedure is a single strand conformational polymorphism analysis.

29. A method of carrying out an analysis procedure simultaneously for multiple samples, each said sample having a different temperature optimum for said procedure, said method comprising the steps of:
providing the thermostat array control system of claim 6;
determining the number of different samples to be examined;
including within the thermostat array a number of columns or channels, or clusters of columns or channels, equal to the number of different samples to be examined;
configuring each said column or channel for carrying out said analysis procedure for one of said multiple samples;
adjusting said temperature controller associated with said thermostat array so as to maintain the temperature at each individual said column or channel at the optimum temperature for carrying out said analysis procedure for an individual said sample;
carrying out said analysis procedure on said different samples simultaneously in each of said columns or channels, each of said individual columns or channels being maintained at the optimum analysis temperature for the individual said sample associated with said individual column; and
obtaining the results of said analysis procedure for each of said samples.

30. The method of claim 29, wherein said analysis procedure is constant denaturant capillary electrophoresis.

31. The method of claim 29, wherein said analysis procedure is a single strand conformational polymorphism analysis.
